(19) United States
(12) Patent Application Publication
(10) Pub. No.: US 2009/0058355 A1
(43) Pub. Date: Mar. 5, 2009

(54) ELECTRIC VEHICLE BATTERY MODULE AND REPLACEMENT SYSTEM

(76) Inventor: Keith M. Meyer, Magnolia, TX (US)

Correspondence Address: CONLEY ROSE, P.C.;David A. Rose, P. O. BOX 3267, HOUSTON, TX, 77253-3267, US

(21) Appl. No.: 12/197,071

(22) Filed: Aug. 22, 2008

Related U.S. Application Data
(60) Provisional application No. 60/968,644, filed on Aug. 29, 2007.

(51) Int. Cl. H01M 2/10; H02J 7/00

(52) U.S. Cl. 320/104

(57) ABSTRACT

An apparatus and method is disclosed for the housing, removal, recharging, and replacing of electric vehicle batteries. The apparatus includes a modular battery carriage and a vehicular battery carriage compartment allowing replacement of electric vehicle batteries to suit the needs of the operator at the service station and an automated service station for the rapid replacement of discharged batteries in electric vehicles with replenished batteries.

### CROSS-REFERENCE TO RELATED APPLICATIONS

This application claims the benefit under 35 U.S.C. § 119(e) of U.S. Provisional Patent Application No. 60/968,644 filed Aug. 29, 2007, the disclosure of which is hereby incorporated herein by reference.

### STATEMENT REGARDING FEDERALLY SPONSORED RESEARCH OR DEVELOPMENT

Not applicable

### BACKGROUND

1. Field of the Invention

This invention relates generally to the field of electric vehicles. More specifically, the invention relates to a method of electric vehicle refueling by battery replacement, recharge, and redistribution through dedicated locations.

2. Background of the Invention

Hydrocarbon emissions exhausted into the atmosphere are the primary form of pollution resultant from fossil fuel powered, internal combustion engines in motor vehicles. Electrically powered vehicles are commonly touted, but relatively unimplemented solution to hydrocarbon pollution. The primary hurdle to wide scale acceptance has been the limited range of electrical vehicles. Unable to travel extended distances on a single charge, the electric vehicle owner must recharge the electric power storage (hereinafter battery) on board the vehicle. This process is time intensive, requiring multiple hours to replenish the “fuel”. Compared to the convenience for internal combustion engines of gas stations, service centers, and the like, the electric vehicle's requirements out-compete the advantageous traits for a significant portion of consumers to invest in the technology. Research and development in high capacity battery design may improve range, but it does little to improve the nuisance of re-fueling.

Batteries in electric vehicles are currently large, cumbersome devices that are self-contained and hermetically sealed from the owner, mechanic, or service technician. Additionally, a significant proportion of electric vehicles contains only one or two of these devices. The substantial size of the batteries limits options in the event a portion of the device fails, or fails to perform at operationally useful levels. Furthermore, the rechargeable batteries have limited lifespan, and are expensive to replace when no longer capable of maintaining storage of an electric charge. While advances in high capacity and quick charge have improved these characteristics, it is at the expense of operational lifetime, durability, and flexibility. Furthermore, this construction also limits options for off line recharging, or charged battery replacement wherein the battery has been removed entirely from the vehicle, and a fresh one has been installed in the intervening time.

Disclosed solutions for online battery replacement require the complete removal of the singular electrical storage devices as detailed in U.S. Pat. No. 7,201,384 and U.S. Pat. No. 5,760,569, all hereby incorporated herein by reference. Requiring the electric vehicle operator to cease all vehicular operations for any period is a significant inconvenience in inclement weather conditions. Additionally, removal and replacement of the total charge storage capacity of an electric vehicle does not allow the operator to purchase only the power required to replenish the vehicle to the operator's needs, wants, or desires. Furthermore, disconnecting the total electrical supply of a vehicle may result in unintended consequences, complications, and inconveniences as the vehicle control computer and accessories such as entertainment and seating position presets, heating air conditioning and ventilation operations, engine control modules and the like are reset by the loss of electrical supply.

Consequently, there is a need for a system to rapidly exchange a modular electric vehicle battery, as an alternative to removing the vehicle from operation to recharge. Accessory to that need is the operational flexibility of an electric vehicle to exchange only a portion of its total electrical charge capacity for maintenance, device failure, partial recharge or similar circumstances in an operator convenient manner.

### SUMMARY OF THE PREFERRED EMBODIMENTS

The electric vehicle battery modular replacement system disclosed herein is comprised of a battery carrier, a vehicle battery compartment, and a service station for the prompt removal and replacement of spent electric vehicle batteries. The charge carrier, or battery, is contained in a battery carrier. The battery carrier is designed to interface with the vehicle battery compartment. In embodiments the battery carrier has one positive conductor and one negative conductor that are coupled to the vehicles powertrain. Additionally, the battery carrier has a computer interface as a means of communicating with the vehicle control computer. In embodiments, the battery carrier has a mechanical means of being moved into the vehicle battery compartment. Preferably, the vehicle battery compartment holds a plurality of battery carriers to provide scalable charge storage within the electric vehicle.

The vehicle battery compartment is designed to allow access from below the vehicle. In embodiments this allows the operator to pull into a service station and park, while their vehicle's battery compartment is accessed from below. Automated devices remove the spent batteries and convey them to a recharging system. A replenished battery carrier is conveyed to operator's vehicle and automatically replaced in preferred embodiments. The discharged cells are stored on racks within the service station for recharging and monitoring.

The service station has an operator interface in order to receive payment for the replacement of the spent battery. Alternatively, the interface may plug into the vehicle allowing the station to determine the status of the vehicle's batteries, the correct action to take, and billing information exchange. Additionally, a communication system transmits this information to a remote computer. Further information transmitted may include the maintenance or operational status of stored batteries.

In embodiments, the service station may serve as the site of alternative electrical power. Any alternative means of generating power may be used to supplement power purchased from the grid to recharge the stored batteries. Additionally, in the event the station detects an excess of electrical generation, or surplus charge storage, the system may return the electrical power to the grid. In preferred embodiments the electrical power returned to the grid is surplus to the demand of the operators and vehicles serviced.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is an exploded perspective view of a modular battery carrier;

FIG. 2 is a side view showing a modular battery carrier integrated in an electric vehicle; and

FIG. 3 illustrates the system of modular battery carrier exchange at a replacement center.

### NOTATION AND NOMENCLATURE

Certain terms are used throughout the following descriptions and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

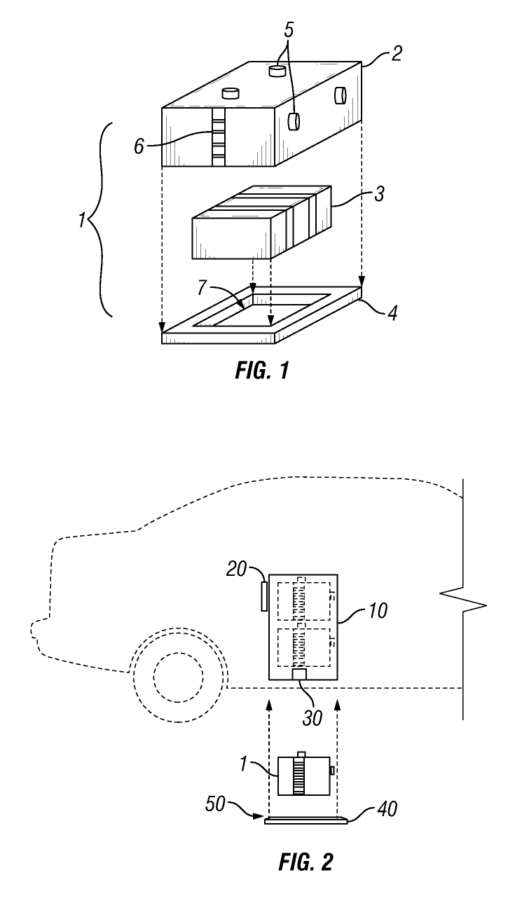

FIG. 1 illustrates a modular stored electric charge carrier assembly 1. (Hereinafter the “battery carriage”.) In embodiments, the battery carriage 1 is an enclosure which may have a cylindrical, square, octagonal, or rectangular shape without limitation, as known by one skilled in the art. In preferred embodiments the battery carriage 1 is rectangular.

In embodiments, the battery carriage 1 is assembled from three devices: the enclosure or outer case 2, the battery 3, and the carriage cover 4 with seal 7. In embodiments the outer case 2 is manufactured from durable material such as metal or a plastic or composite material, such as, without limitation, polypropylene, polyethylene, poly-vinyl chloride, acrylonitrile butadiene styrene or composites thereof. In embodiments, the carriage cover 4 is made of similar or same material as the enclosure 2. In embodiments the carriage cover 4, may make up any portion of the battery carrier such as but not limited to: the bottom, the sides, the top or an internal portion. The carriage cover 4 seals the battery 3 from environmental exposure. The carriage cover 4 provides a means of retaining the battery 3 in the battery carriage 1. In embodiments the battery 3 may be retained by the carriage cover 4 by screws, bolts, fasteners, latches, or other means without limitation of releasably retaining an object in an enclosure as known to one skilled in the art. In an embodiment the outer case 2 contains interfaces 5. Interfaces 5 comprise a means to couple the vehicle and the battery, the interfaces may comprise a direct or indirect coupling means. In alternative embodiments, the interfaces 5 may be battery terminals, battery poles, or battery posts without limitation. In further embodiments the interfaces 5 may be located on the case, without limitation, on the top, on the sides, or a combination thereof. In an embodiment one post is the positive terminal or the battery, the opposite, adjacent, or nearby post is the negative terminal without limitation on post location on the outer case 2. In embodiments these interfaces 5 serve to discharge stored electrical energy to the vehicle, and/or to recharge the internal battery 3. In an embodiment the outer case 2 contains an external device 6 for introduction and removal of the battery carriage 1 from the vehicle. The external device 6 includes a retention means configured for retaining the charge storage device in the enclosure and at least one release means configured for releasing the charge storage device from the retention means.

In alternative embodiments, without limitations, the device 6 may be any means of mechanically manipulating the battery carriage 1 such as a gear strip, a clamp location, a receptacle, a bushing or other device without limitation.

Internal battery 3, is a rechargeable charge storage device composed of any material as known to one skilled in the art, such as, but not limited to Nickel-Metal Halide (NiMH), Sealed Lead-Acid (SLA), or Lithium-Ion. In embodiments the internal battery may have any specifications associated with charge storage devices, traction batteries, batteries, or capacitors utilized in electric vehicles as known to one skilled in the art. In the preferred embodiment, the battery 3 interfaces with the outer case 2, to couple the battery 3 to the vehicle, or recharging devices.

FIG. 2 illustrates an embodiment of the battery carrier 1 showing an introduction and interface with an electric vehicle. In an embodiment, the electric vehicle is constructed with a vehicle battery compartment 10. In one embodiment the vehicle battery compartment 10 is enclosed within the bodywork of the electric vehicle with access to the compartment is through the bottom of the vehicle. In alternative embodiments the vehicle battery compartment 10 comprises part of the structure of the vehicle. The vehicle battery compartment 10 includes electrical and computer interface 20, a mechanical battery carrier loading mechanism 30, and an external compartment covering 40. Battery carrier loading mechanism 30 is a means to move battery carriage 1 into vehicle battery compartment 10. In certain instances battery carrier loading mechanism 30 releasably connects to external device 6, in order to mechanically move battery carriage 1. The mechanism 30 includes a first member that engages the battery carriage 1 and a lifting mechanism that raises and lowers the battery carriage 1 within the compartment 10. The lifting mechanism may be electrically operated. Battery carriage loading mechanism releasably retains battery carriage 1 in vehicle battery compartment and may include a releasably latch.

In embodiments, battery carriers 1 are loaded vertically into the vehicle battery compartment 10 by the mechanical battery carrier loading mechanism 30. In preferred embodiments, the battery carriers 1 are arranged vertically within the battery compartment 10 or in alternative embodiments the battery carriers may be arranged horizontally, into individual compartments, or any conformation known to one skilled in the art, without limitation. In an embodiment, the vehicle battery compartment has a sealable cover, or covering 40. In preferred embodiments the external compartment covering 40 has connection means for connecting the covering 40 to the vehicle by hinges, fasteners, quick-releases or the like, without limitation. In preferred embodiments the external compartment cover 40 provides a seal 50 to exclude exterior contaminants from entering the vehicle battery compartment 10.

In embodiments battery carrier loading mechanism 30 interfaces with the battery carrier 1 mechanically for positing the battery carrier 1 within the vehicle battery compartment 10, to sufficiently connect or couple the battery to the vehicle electrically. In preferred embodiments, the vehicle battery compartment contains an electrical and a computer interface 10, so that the vehicle may use the stored electrical energy to power the electric motors and the vehicle control computer can assess the quantity of energy stored in the battery and report to the driver.

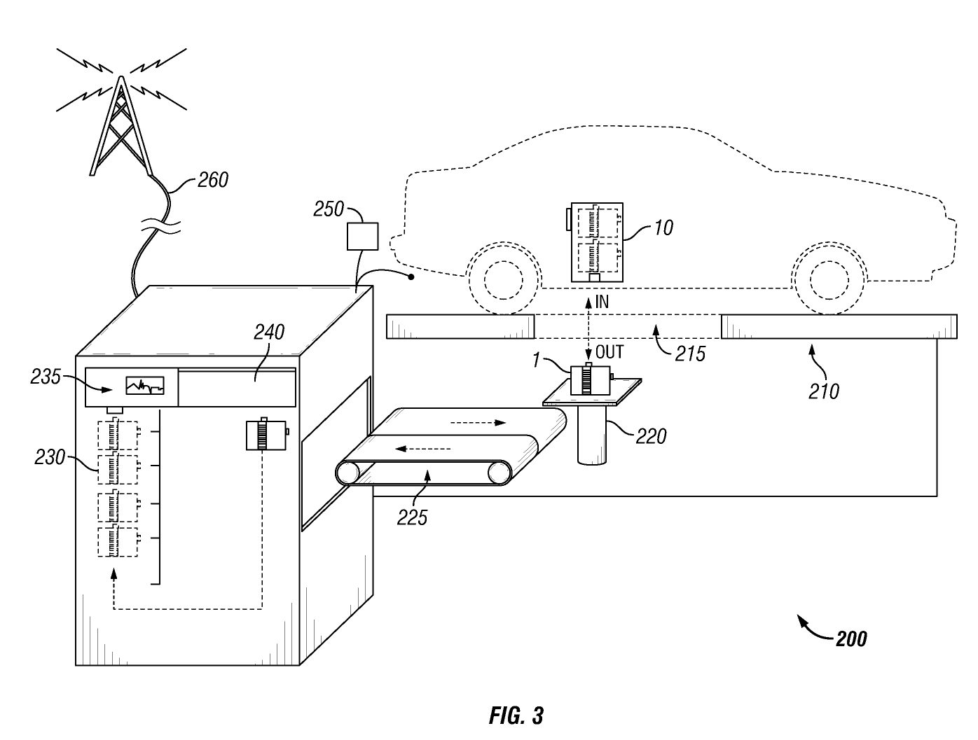

FIG. 3 illustrates an embodiment of a service station to remove and replace battery carriers from the electric vehicle as well as the method for designing a station to replenish discharged batteries. In embodiments platform 210 is constructed so that it contains an opening 215 directly beneath the vehicle battery compartment 10 that leads to an access area such as a room, chamber, hall, passage, or similar space without limitation. In preferred embodiments the opening 215 is long enough to access vehicle battery compartments in any location underneath an electric vehicle. In further embodiments, the platform opening 215 is narrow enough to fit within the track, or between the wheels, of an electric vehicle. In alternative embodiments, platform opening 215 is covered by a positioning means such as a movable grate, panel, rack, or similar element, without limitation, to facilitate vehicle positioning upon the platform prior to revealing the platform opening 215.

In an embodiment, an interchange system or a battery removal replacement system 220 is found in the space beneath the platform 210 and extends to a first position adjacent to the opening of the vehicle battery compartment 10, retrieves the battery carrier 1 and retracts once the battery carrier 1 has been secured to a second position adjacent to a conveyor 225. In embodiments the battery removal replacement system 220 may be comprised of actuators, pistons, robotic arms, or similar devices without limitation, such that the battery carrier 1 is moved approximately vertically downward from the bottom of the electric vehicle to the second position. In an embodiment, the battery carrier 1 is placed on a conveyor system 225 for transporting the battery from the system 220 to a charging station 230. In embodiments, the conveyor system 225 may be belts, rollers, ramps, slides, or other similar powered or un-powered devices for transporting the battery carrier 1 to the charging station 230. In further embodiments, the conveyor system 225 contains the capacity to transport battery carriers 1 from the charging station 230 to the battery removal replacement system 220. In embodiments the conveyor system 225 may be comprised of two devices, a reversible device, or similar designs for opposite directional transport of the battery carrier 1, without limitation.

In an embodiment, charging station 230 contains a charge replenishing and monitoring system 235, a communications system 240, a user/vehicle interface 250, and a connection to an electrical power source 260. In embodiments battery carriers 1 are introduced to the charging station by the conveyor system 225. In alternative embodiments, the battery carrier 1 may be moved into the charging station 230, or moved into position within the charging station 230 by a transfer mechanism. In embodiments a transfer mechanism may be, without limitation, comprised of actuators, pistons, robotic arms, similar devices or combinations thereof. In embodiments the battery carrier 1 is positioned to interface with the charge replenishing and monitoring system 235. In embodiments the battery carrier 1 may be coupled to the charge replenishing and monitoring system 235 by cables, wires, or similar connections known to one skilled in the art. In embodiments the battery carrier 1 is placed in a matrix of stored battery carriers within the charging station 230 charge replenishing and monitoring system 235. In further embodiments, the stored battery carrier matrix may be comprised of various support means such as shelves, racks, belts, rotisseries, or similar devices without limitation, as known to one skilled in the art.

In an embodiment the communication system 240 of charge station 230 connects the station to a communication network such as the internet, phone network, satellites or radio transmitter, without limitation. In an embodiment the charge station 230 contains a user/vehicle interface 250 that couples to the communication system 240. In an embodiment the communication system 240 connects the recharge station to a remote monitoring center or computer. In embodiments the communication system relays user input, and vehicle data from the user/vehicle interface to a remote monitoring center or computer. In further embodiments, the communication system 240 relays customer payment input from the user/vehicle interface 250 to a remote monitoring center or computer. In embodiments, the communication center 240 receives instructions from a remote monitoring center or computer for the exchange of the electric vehicle operator's battery carrier(s) 1 to be carried out by the replacement center 200. In additional embodiments, the charge replenishing and monitoring system 235 verifies the stored battery carriage(s) 1 are free of defects, and require no maintenance and communicates information pertaining to the status of the battery carriage(s) 1 to the monitoring center or computer. In alternative embodiments, the remote monitoring center or computer is part of the replacement center 200. In additional embodiments the remote monitoring center or computer is a business system of any type, specification, or layout that is known to one skilled in the art. In embodiments the replacement center 200 is connected to an electrical power source.

In embodiments the vehicle operator and electric vehicle arrive at replacement center 200 and drive upon special platform 210 where the operator parks the electric vehicle. In an embodiment the electric vehicle operator accesses the charging station 230 by customer interface 250, or alternatively by connecting a vehicle interface 250 to the electric vehicle, or both. In an embodiment the customer/vehicle interface 250 is comprised of a payment device. In an embodiment, the charging station 230, by communication system 240, contacts remote charging station 230 operators or computers and in conjunction with electric vehicle operator input, selects the quantity of the charge depleted in the battery carrier 1 and removes the battery carrier 1 from the vehicle battery compartment 10 and exchanges it with the charging station 230. In an embodiment, once customer's needs are established and payment received, the vehicle platform opening 215 is accessed, battery carrier 1 is removed from vehicle battery compartment 10 by a battery removal replacement system 220, transported to charging station 230 by battery carrier conveyor 225, and connected to the battery carrier monitoring and charging system 235. In an embodiment, the charging station 230 contains a battery charge monitoring system 235 by which the charging station 230 selects the battery carrier(s) 1 to meet the customer's needs. In an embodiment, a replenished battery carrier 1 is selected, transported from the charging station 230, to the vehicle in the reverse direction along conveyor 225, and introduced to the vehicle battery compartment 10 by the battery removal replacement system 220.

In the preferred embodiment the replacement center 200 is connected to the electrical power grid 260. In further embodiments the replacement center 200 is connected additionally to alternative electrical energy sources such as wind turbines, solar panels, water turbines, or combinations there of, without limitation. In additional embodiments the replacement center 200 is connected to the electrical power grid 260 and alternative sources of electrical energy. In embodiments, the replacement center may act as a temporary electrical storage for the electrical power grid 260. In an embodiment during heavy electrical demand, the replacement center 200 may return electrical energy stored in surplus battery carriage(s) 1 that are stored in the charging station 230 to the electrical power grid 260. In embodiments, the return of electrical energy to the electrical power grid 260 may be compensated by the managing utility company. In further embodiments the charge replenishing and monitoring system 235 controls the quantity of power available for transaction to the electrical power grid 260 through the replacement center 200, to ensure sufficient supply of battery carriage(s) 1 for customer replacement.

The embodiments set forth herein are merely illustrative and do not limit the scope of the invention or the details therein. It will be appreciated that many other modifications and improvements to the disclosure herein may be made without departing from the scope of the invention or the inventive concepts herein disclosed. Because many varying and different embodiments may be made within the scope of the present inventive concept, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. An apparatus for storing a charge to power an electric vehicle, comprising:
an enclosure adapted to be mounted within the electric vehicle;
one or more charge storage devices removably mounted within the enclosure to provide power, at least in part, to the electric vehicle;
a base connected to the enclosure with an aperture to pass the charge storage therethough; and
an environmental cover covering the aperture.

2. The apparatus of claim 1, wherein the enclosure comprises an interface for coupling the charge storage device to the electric vehicle.

3. The apparatus of claim 2, wherein the interface comprises computer connections.

4. The apparatus of claim 2, wherein the interface comprises terminals configured for coupling the charge storage device to the interface.

5. The apparatus of claim 1, wherein the enclosure comprises at least one retention means configured for retaining the charge storage device in the enclosure.

6. The apparatus of claim 5, wherein the enclosure comprises at least one release means, configured for releasing the charge storage device from the retention means.

7. The apparatus of claim 1, wherein the enclosure comprises an external retention means, configured for releasably retaining the enclosure in the electric vehicle.

8. The apparatus of claim 1, wherein the charge storage device comprises a device chosen from the group consisting of: a battery, a capacitor, a fuel cell, and/or combinations thereof.

9. The apparatus of claim 1, wherein the base comprises a sealing means to exclude contaminants.

10. An apparatus for retaining at least one charge storage device within a compartment of an electric vehicle, comprising:
an opening configured to pass at least one charge storage device therethrough, the opening having an environmental cover;
an internal mechanism for installation and removal of at least one charge storage device internal to the compartment;
a retention means for the releasable retention of the charge storage device within the compartment;
an interface for coupling the at least one charge storage device to the electric vehicle; and
a closure member configured for reversibly separating the compartment from the environment.

11. The apparatus of claim 10, wherein the interface comprises computer connections.

12. The apparatus of claim 10, wherein the interface comprises terminals for coupling the at least one charge storage device to the electric vehicle.

13. The apparatus of claim 10, wherein the closure member includes a sealing means to exclude contaminants from the compartment.

14. A service facility for servicing electric vehicles, comprising:
an interchange system for accessing an electric vehicle compartment and removing and installing at least one charge storage device;
a replenishing system for replenishing at least one charge storage device exterior to the electric vehicle compartment; and
an electric transfer system for accessing the energy stored in the at least one charge storage device for distribution to a municipal electricity grid.

15. The service facility of claim 14, wherein the interchange system further comprises:
at least one platform having an opening adapted to be positioned adjacent to the closure member of the electric vehicle;
a conveyor positioned below the platform proximal to the opening;
a lift having a first position adjacent to the closure member of the electric vehicle and a second position adjacent to the conveyor;
a release means to remove at least one charge storage device from the electric vehicle onto the lift; and
an installation member to position at least one charge storage device into the electric vehicle.

16. The service facility of claim 14, wherein the replenishing system further comprises:
an enclosure to house at least one charge storage device;
a connector to couple the enclosure to a charge source;
an interface to couple the connector to the at least one charge storage device housed in the enclosure;
a regulator to regulate the replenishing of the at least one charge storage device housed in the enclosure;
a monitor to monitor the condition of the at least one charge storage device housed in the enclosure;
a user interface to exchange the at least one charge storage device between the enclosure and an electric vehicle; and
a communication system to transmit a signal indicative of the at least one charge storage device status and a signal indicative of a transaction.

17. The service facility of claim 16 wherein the communication system transmits the signal to a remote municipal utility provider.

18. The service facility of claim 16 wherein the communication system transmits the signal to a remote business.

19. A method for replacing a charge storage device in an electric vehicle, comprising:
removing at least one charge storage device from the electric vehicle compartment;
transporting at least one charge storage device to a replenishing facility to replenish the at least one charge storage device;
transporting at least one replenished charge storage device to the electric vehicle compartment; and
loading the at least one charge storage device into the electric vehicle compartment.

20. The method of claim 19, further comprising:
replenishing the removed at least one charge storage device;
storing the removed at least one charge storage device;
monitoring the removed at least one charge storage device; and
installing the at least one charge storage device in at least one alternate electric vehicle.
